(19) United States
(12) Patent Application Publication
(10) Pub. No.: US 2010/0028729 A1
(43) Pub. Date: Feb. 4, 2010

(54) FUEL CELL POWER PLANT INCLUDING A VARIABLE RESISTIVE DEVICE

(76) Inventors: Michael S. Billups, Middletown, CT (US); Craig E. Evans, Manchester, CT (US); Praveen Narasimhamurthy, Vernon, CT (US); Evan C. Rege, West Hartford, CT (US); William C. Rogers, Suffield, CT (US); Wesley E. Sedlacek, South Windsor, CT (US); Frederic W. Stucklen, East Windsor, CT (US)

Correspondence Address: CARLSON, GASKEY & OLDS, P.C., 400 WEST MAPLE ROAD, SUITE 350, BIRMINGHAM, MI, 48009, US

(21) Appl. No.: 12/443,748

(22) PCT Filed: Nov. 28, 2006
(86) PCT No.: PCT/US06/61271

§ 371 Date: Mar. 31, 2009

(51) Int. Cl. H01M 8/04

(52) U.S. Cl. 429/13; 429/23

(57) ABSTRACT

A fuel cell power plant (20) includes a variable resistive device (30). In one example, the variable resistive device (30) is operationally associated directly with a cell stack assembly (22). The controller (32) selectively varies an electrical resistance of the variable resistive device (30) responsive to an operating condition of the power plant (20). By using a variable resistive device, a variety of control functions are possible to address various operating conditions of the power plant (20) or the cell stack assembly (22).

### TECHNICAL FIELD

This disclosure generally relates to fuel cell power plants and more particularly to controlling an operating condition of a fuel cell power plant.

### DESCRIPTION OF THE RELATED ART

Fuel cell power plants are well known. Cell stack assemblies and other known components operate in a known manner to provide electrical power. The applications for fuel cell power plants vary. Depending on the installation, different features and functions are required of different fuel cell power plants.

It has been proposed to include a voltage limiting device in a fuel cell power plant assembly for managing an operating condition of the assembly. One approach includes using different devices for different operating condition controls. For example, one voltage limiting device may be used during a start up operation while a different voltage limiting device may be used during a shutdown operation. While that approach has proven useful, there are limitations.

For example, adding additional devices to a fuel cell power plant introduces additional cost. It is therefore not possible to add such devices in an unlimited manner. Additionally, such voltage limiting devices tend to be designed for one particular type of fuel cell power plant and for only one operating condition. Further, such voltage limiting devices do not address the needs of all conditions within an operating scenario for which the device is intended. For example, a fixed voltage limiting device during a start up operation does not provide the ability to avoid non-recoverable decay as some of the cells go negative.

U.S. Pat. No. 6,887,599 shows one approach to adding an auxiliary load to control voltage levels during start up and shut down procedures. U.S. Pat. No. 7,041,405 shows an approach for cyclically switching an auxiliary load into and out of a fuel cell stack external circuit.

Even with such improvements, there is a desire in the industry to be able to provide more customized control over various operating conditions in a fuel cell power plant.

### SUMMARY

An exemplary method of controlling operation of a fuel cell power plant using a variable resistive device includes selectively varying an electrical resistance of the variable resistive device responsive to an operating condition of the fuel cell power plant.

In one example, the electrical resistance is selectively varied responsive to a condition of a cell stack assembly within the fuel cell power plant.

For different operating conditions, a single variable resistive device can be controlled to introduce a different resistance depending on the operating condition. Using such a device and a control strategy consistent with the examples disclosed in this description provides the ability to customize the control of various operating conditions of a fuel cell power plant while minimizing additional cost because there is no need for multiple devices to achieve the multiple functions.

An exemplary fuel cell power plant includes a cell stack assembly. At least one other component is operationally associated with the cell stack assembly. A variable resistive device is operationally associated with at least one of the cell stack assembly or the other component. A controller selectively controls an electrical resistance of the variable resistive device responsive to an operating condition of the fuel cell power plant.

Various features and advantages will become apparent to those skilled in the art from the following detailed description. The drawings that accompany the detailed description can be briefly described as follows.

### BRIEF DESCRIPTION OF THE DRAWINGS

FIG. 1 schematically shows selected portions of an example fuel cell power plant.

FIG. 2 is a flow chart diagram summarizing one example control approach.

FIG. 3 schematically shows selected portions of another example embodiment.

FIG. 4 is a timing diagram showing one example control signal.

FIG. 5 is another timing diagram showing another example control signal.

FIG. 6 is a timing diagram showing another example control signal.

### DETAILED DESCRIPTION

The disclosed examples relate to customized control of various operating conditions or functions in a fuel cell power plant. In a disclosed example, a single variable resistive device is used to provide a variety of control functions. By selecting the resistance based upon the operating condition, the disclosed examples allow for realizing a variety of control functions for various fuel cell power plant operating conditions in an economical manner.

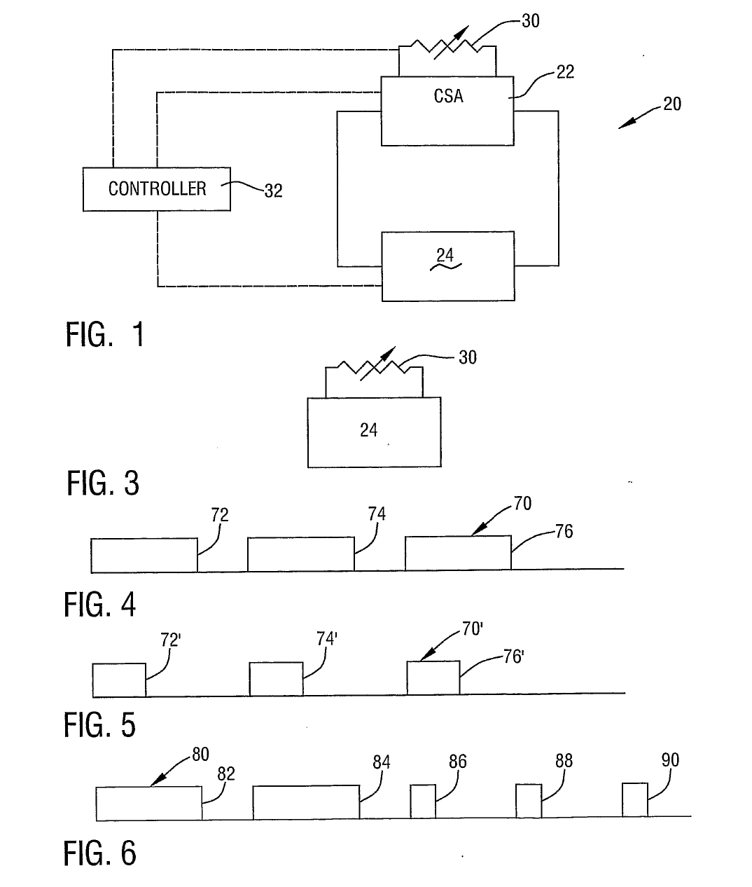

FIG. 1 schematically shows selected portions of an example fuel cell power plant 20, including a cell stack assembly (CSA) 22. The example power plant 20 includes at least one other component 24 operationally associated with the cell stack assembly 22. The types of components used in fuel cell power plants are known. Examples include pumps, heat exchangers, accumulators, demineralizers, enthalpy recovery devices, coolant loops and fuel processors. The component schematically shown at 24 represents one or all of the other components in the example power plant 20. Those skilled in the art who have the benefit of this description will realize what types of components are included in the various types of fuel cell power plants.

The example of FIG. 1 includes a variable resistive device 30. In this example, the variable resistive device 30 is operationally associated with the CSA 22. A controller 32 selectively controls the electrical resistance of the variable resistive device 30 responsive to an operating condition of the fuel cell power plant 20. In some examples, the operating condition will be a condition of one or more portions of the fuel cell power plant 20. In some examples, the operating condition will depend only on a feature or condition of the CSA 22. The controller 32 in one example is programmed to monitor a plurality of different operating conditions and to use appropriate electrical resistances available from the variable resistive device 30 to achieve a desired characteristic of an existing operating condition or to provide a desired function, for example.

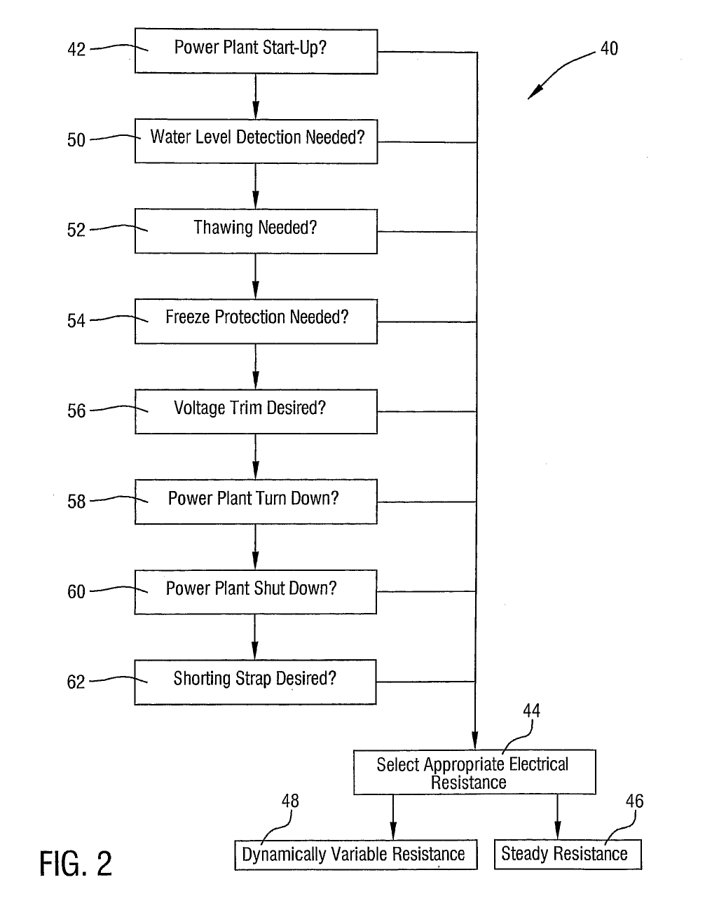

FIG. 2 includes a flowchart diagram 40 summarizing one example approach that an example controller 32 utilizes for selecting an appropriate electrical resistance of the variable resistive device 30 to achieve a desired goal. In this example, the flowchart 40 includes a decision at 42 where the controller 32 determines whether the power plant 20 is in a start-up operating condition. Using a voltage limiting device during a start up condition provides advantages and efficiencies. The controller 32, therefore, determines if the power plant 20 is in a start-up operating condition at 42. At 44, the controller 32 selects an appropriate resistance based upon the determination whether the start-up operating condition exists.

In the illustrated example, the controller 32 has the ability to control the electrical resistance of the variable resistive device in a plurality of different manners. As schematically shown at 46, the electrical resistance may be selected and maintained at a steady value throughout the current operating condition. Alternatively, as schematically shown at 48, the controller 32 dynamically varies the electrical resistance within a particular operating condition. In such an example, not only does the controller vary the resistance to different electrical resistance values for different operating conditions, but also has the ability to vary the electrical resistance value within a particular operating condition.

For example, during a start-up condition the electrical resistance of the variable resistive device 30 in one example is dynamically varied to maintain a constant, low voltage during start-up fuel introduction. In one example this is accomplished by monitoring the voltage on all the cells of the CSA 22 and responsively varying the electrical resistance of the variable resistive device 30 to ensure that the voltage on all of the cells remains positive. This approach facilitates reducing any non-recoverable decay that is otherwise associated with a start-up operating condition.

The ability to dynamically vary the resistance during an operating condition may be based upon dynamically determining characteristics of the cell stack assembly 22, for example. One example includes a sensor arrangement to provide the appropriate information to the controller 32. In one example, empirical testing is done to determine particular voltage profiles and associated decay characteristics. The controller 32 is provided with a database or information such as a look up table that includes corresponding resistance values that should be selected by the controller 32 during appropriate portions of a start-up operation to achieve a desired decay characteristic, for example.

The example of FIG. 2 also includes a determination whether water level detection is desired at 50. With a variable resistive device 30 as schematically shown in FIG. 1, when the device is appropriately situated within the fuel cell power plant 20, it is possible to use a known technique for making a water level determination using the variable resistive device 30. This example approach has the advantage of making a water level determination even when dedicated water level sensors have not yet been activated because of the current condition of the sensors or the power plant 20. When water level detection using the variable resistive device 30 is desired, the controller 32 selects an appropriate resistance at 44.

Another feature available from the illustrated example is to provide a thawing function, which may be needed for some freeze capable fuel cell power plant installations, for example. At 52, the controller 32 determines whether thawing is needed. By having the selectively variable resistive device 30 appropriately situated within the power plant 20, it is possible to use that device as a heater, for example, for providing a thawing function. When thawing is needed, the controller 32 selects an appropriate resistance at 44.

Another function available from the illustrated example is a freeze protection function. The controller 32 makes a determination at 54 whether freeze protection is desired during operation or subsequent to operation of a fuel cell power plant before freezing may have occurred. When freeze protection is desired, an appropriate resistance for the variable resistive device 30 is selected and utilized.

A voltage trim function is available at 56. There are various operating conditions where trimming a voltage of one or more cells in the CSA 22, for example, may be desired. The controller 32 in one example is programmed to determine when such a condition exists and to control the variable resistive device 30 in a corresponding manner to achieve the desired effect.

At 58, the controller 32 is able to determine whether a power plant turn down operating condition exists or is desired. If so, the controller 32 makes an appropriate resistance selection at 44 to control the variable resistive device 30 to achieve the desired effect.

A voltage limiting device can be useful during a shutdown procedure of a fuel cell power plant. The example of FIG. 2 includes a determination at 60 whether a shutdown procedure is ongoing or about to be implemented, for example. If a voltage limiting function within a shutdown procedure is desired, the controller 32 selects an appropriate resistance to achieve the desired effect. In one example, the resistance used for shutdown is different than that used for power plant start-up, for example.

Another function available in the example of FIG. 2 is a shorting strap function. At 62, the controller 32 determines whether a shorting strap function is desired and appropriately controls the variable resistive device 30 to provide that function.

It may be possible for each of the resistance determinations in the example of FIG. 2 to be different electrical resistances. In some examples, some of the electrical resistances for different operating conditions will be the same. Given this description, those skilled in the art will be able to select appropriate resistance values for corresponding operating conditions of the particular fuel power plant with which they are dealing.

As can be appreciated, a single variable resistive device 30 and an appropriate control strategy allows for providing a variety of functions to achieve various desired characteristics of different operating conditions for a fuel cell power plant. The illustrated example, therefore, provides the advantage of minimizing expense by minimizing the number of components required to provide a variety of advantageous control functions within a fuel cell power plant assembly.

In one example, the variable resistive device 30 is operationally associated directly with the CSA 22 as schematically shown in FIG. 1. In another example schematically shown in FIG. 3, a variable resistive device 30 is operationally associated directly with at least one other component 24 of a fuel cell power plant 20. Given this description, those skilled in the art will be able to select an appropriate way of incorporating a variable resistive device into an appropriate portion of a fuel cell power plant to meet their particular needs.

In one example, the controller 32 uses a control signal to selectively vary the electrical resistance of the variable resistive device. In an illustrated example as schematically shown in FIG. 4, a control signal 70 comprises a plurality of pulses 72, 74, 76, etc. In this example, the controller 32 uses pulse width modulation on the control signal 70 to selectively vary the electrical resistance provided by the variable resistive device 30. In one example, selectively varying the duty cycle of the control signal achieves the various electrical resistances needed for the various operating conditions. FIG. 5 schematically shows a control signal 70′ where pulses 72′-76′ have a shorter on time compared to those in FIG. 4. As can be appreciated from FIGS. 4 and 5, a different duty cycle is used in each instance. In one example, the control signal 70 as schematically shown in FIG. 4 is used to achieve a first electrical resistance for a first operating condition of the fuel cell power plant 20. The control signal 70′ is used to achieve a second, different electrical resistance for a second, different operating condition.

In an example where the controller can dynamically change the electrical resistance even during a particular operating condition or responsive to a particular characteristic or condition of the CSA 22, a control strategy as schematically shown in FIG. 5 as used in one example. A control signal 80 in this example includes pulses 82 and 84 of a first duration. When a corresponding change occurs in a voltage of the cell stack assembly 22, for example, a different resistance is desired in this example. The controller 32 responds by altering the duty cycle of the control signal 80 to provide longer pulses at 86, 88 and 90, for example.

In one example, the variable resistive device 30 comprises a resistor and a plurality of switches such as MOSFETs that are arranged to respond to a control signal from the controller 32 such that operating the different switches based upon the selected pulse width modulation achieves the desired resistance provided by the variable resistive device 30. Given this description, those skilled in the art will be able to select an appropriate variable resistive device and an appropriate control arrangement to meet their particular needs.

The preceding description is exemplary rather than limiting in nature. Variations and modifications to the disclosed examples may become apparent to those skilled in the art. The scope of legal protection can only be determined by studying the following claims.

1-19. (canceled)

20. A fuel cell power plant, comprising
a cell stack assembly;
at least one other power plant component operationally associated with the cell stack assembly;
a variable resistive device operationally associated with at least one of the cell stack assembly or the at least one other power plant component, the variable resistive device having a selectively variable electrical resistance; and
a controller that controls the electrical resistance of the variable resistive device responsive to an operating condition of the fuel cell power plant,
the controller selecting an electrical resistance of the variable resistive device to provide at least one of a freeze prevention function, a thawing function or a water level detection function.

21. The fuel cell power plant of claim 20, wherein the controller controls the electrical resistance to control a load on the cell stack assembly.

22. The fuel cell power plant of claim 20, wherein the controller
selects a first electrical resistance of the variable resistive device during a start up of the fuel cell power plant; and
selects a second electrical resistance of the variable resistive device during a shut down of the fuel cell power plant.

23. The fuel cell power plant of claim 22, wherein the controller
selectively varies the first electrical resistance during the start up of the fuel cell power plant.

24. The fuel cell power plant of claim 22, wherein
the controller selects at least one third electrical resistance to thereby provide at least one other function useful during another operating condition of the fuel cell power plant and
the at least one other function comprises at least one of
a shorting strap function;
a voltage trimming function; or
a power plant turn-down function.

25. The fuel cell power plant of claim 20, wherein the controller uses a resistance selecting signal comprising pulse width modulation to control the variable electrical resistance.

26. The fuel cell power plant of claim 25, wherein the controller varies a duty cycle of the resistance selecting signal to thereby control the variable electrical resistance.

27. The fuel cell power plant of claim 20, wherein the controller controls the variable electrical resistance responsive to a condition of the cell stack assembly.

28. The fuel cell power plant of claim 27, wherein the controller controls the variable electrical resistance to maintain a desired voltage of the cell stack assembly.

29. The fuel cell power plant of claim 20, wherein the variable resistive device is electrically coupled with the at least one other power plant component.

30. The fuel cell power plant of claim 20, wherein the variable resistive device is electrically coupled with the cell stack assembly.

31. A method of controlling an operating condition of a fuel cell power plant having a variable resistive device, the method comprising
selectively varying an electrical resistance of the variable resistive device responsive to an operating condition of the fuel cell power plant to perform at least one of a freeze prevention function, a thawing function, or a water level detection function.

32. The method of claim 31, comprising
selectively varying the electrical resistance to control a load on the cell stack assembly.

33. The method of claim 31, comprising
selecting a first electrical resistance during a start up of the fuel cell power plant; and
selecting a second electrical resistance during a shut down of the fuel cell power plant.

34. The method of claim 33, comprising
selectively varying the first electrical resistance during the start up of the fuel cell power plant.

35. The method of claim 33, comprising
selecting at least one third electrical resistance;
providing at least one other function useful during another operating condition of the fuel cell power plant using the at least one third electrical resistance.

36. The method of claim 35, comprising providing at least one of
a shorting strap function;
a voltage trimming function; or
a power plant turn-down function
as the at least one other function.

37. The method of claim 31, comprising
controlling the electrical resistance responsive to a condition of the cell stack assembly.

38. The method of claim 37, comprising
varying the electrical resistance to maintain a desired voltage of the cell stack assembly.
